(19) United States
(12) Patent Application Publication
(10) Pub. No.: US 2013/0093751 A1
(43) Pub. Date: Apr. 18, 2013

(54) GESTURE BANK TO IMPROVE SKELETAL TRACKING

(71) Applicants: Szymon Stachniak, Kirkland, WA (US); Ke Deng, Sammamish, WA (US); Tommer Leyvand, Seattle, WA (US); Scott M. Grant, Woodinville, WA (US)

(72) Inventors: Szymon Stachniak, Kirkland, WA (US); Ke Deng, Sammamish, WA (US); Tommer Leyvand, Seattle, WA (US); Scott M. Grant, Woodinville, WA (US)

(73) Assignee: MICROSOFT CORPORATION, Redmond, WA (US)

(21) Appl. No.: 13/271,857

(22) Filed: Oct. 12, 2011

(51) Int. Cl. G06T 15/00

(52) U.S. Cl. 345/419

(57) ABSTRACT

A method for obtaining gestural input from a user of a computer system. In this method, an image of the user is acquired, and a runtime representation of a geometric model of the user is computed based on the image. The runtime representation is compared against stored data, which includes a plurality of stored metrics each corresponding to a measurement made on an actor performing a gesture. With each stored metric is associated a stored representation of a geometric model of the actor performing the associated gesture. The method returns gestural input based on the stored metric associated with a stored representation that matches the runtime representation.

### BACKGROUND

A computer system may include a vision system to acquire video of a user, to determine the user's posture and/or gestures from the video, and to provide the posture and/or gestures as input to computer software. Providing input in this manner is especially attractive in video-game applications. The vision system may be configured to observe and decipher real-world postures and/or gestures corresponding to in-game actions, and thereby control the game. However, the task of determining a user's posture and/or gestures is not trivial; it requires a sophisticated combination of vision-system hardware and software. One of the challenges in this area is to intuit the correct user input for gestures that are inadequately resolved by the vision system.

### SUMMARY

One embodiment of this disclosure provides a method for obtaining gestural input from a user of a computer system. In this method, an image of the user is acquired, and a runtime representation of a geometric model of the user is computed based on the image. The runtime representation is compared against stored data, which includes a plurality of stored metrics each corresponding to a measurement made on an actor performing a gesture. With each stored metric is associated a stored representation of a geometric model of the actor performing the associated gesture. The method returns gestural input based on the stored metric associated with a stored representation that matches the runtime representation.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows aspects of an example application environment in accordance with an embodiment of this disclosure.

FIG. 2 illustrates an example high-level method for obtaining gestural input from a user of a computer system in accordance with an embodiment of this disclosure.

FIGS. 3 and 4 schematically show example geometric models of a human subject in accordance with embodiments of this disclosure.

FIG. 5 illustrates an example gesture bank-population method in accordance with an embodiment of this disclosure.

FIG. 6 shows an example motion-capture environment in accordance with an embodiment of this disclosure.

FIG. 7 shows a gesture bank in accordance with an embodiment of this disclosure.

FIG. 8 illustrates an example method for extracting gestural input from a runtime geometric model in accordance with an embodiment of this disclosure.

FIG. 9 schematically shows an example vision system in accordance with an embodiment of this disclosure.

FIG. 10 shows an example controller of a computer system in accordance with an embodiment of this disclosure.

FIG. 11 schematically shows selection of a stored metric from a cluster in accordance with an embodiment of this disclosure.

FIG. 12 schematically shows selection of a stored metric that follows a predefined trajectory in accordance with an embodiment of this disclosure.

### DETAILED DESCRIPTION

Aspects of this disclosure will now be described by example and with reference to the illustrated embodiments listed above. Components, process steps, and other elements that may be substantially the same in one or more embodiments are identified coordinately and are described with minimal repetition. It will be noted, however, that elements identified coordinately may also differ to some degree. It will be further noted that the drawing figures included in this disclosure are schematic and generally not drawn to scale. Rather, the various drawing scales, aspect ratios, and numbers of components shown in the figures may be purposely distorted to make certain features or relationships easier to see.

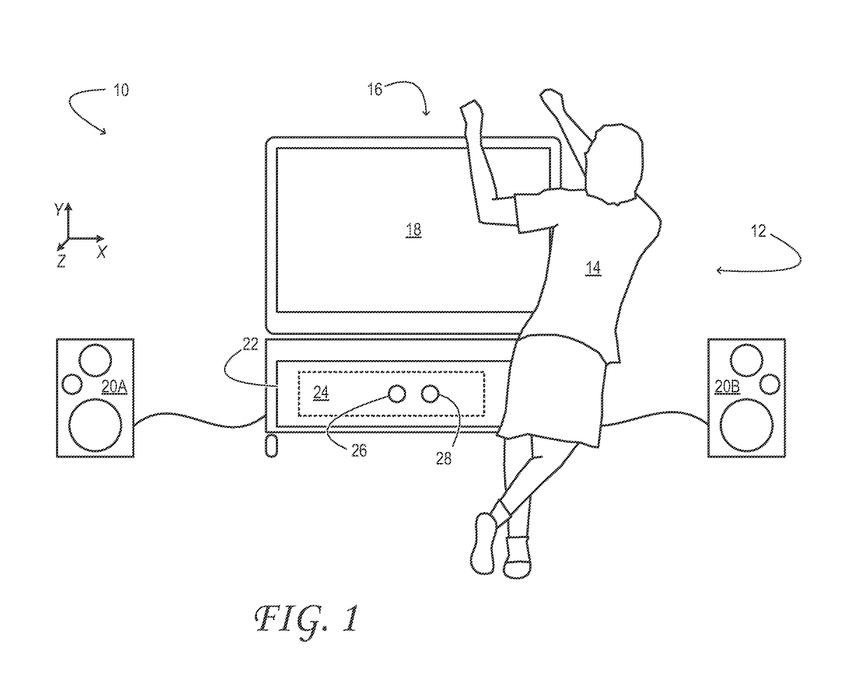

FIG. 1 shows aspects of an example application environment 10. The application environment includes scene 12, in which computer-system user 14 is located. The drawing also shows computer system 16. In some embodiments, the computer system may be an interactive video-game system. Accordingly, the computer system as illustrated includes a high-definition, flat-screen display 18 and stereophonic loudspeakers 20A and 20B. Controller 22 is operatively coupled to the display and to the loudspeakers. The controller may be operatively coupled to other input and output componentry as well; such componentry may include a keyboard, pointing device, head-mounted display, or handheld game controller, for example. In embodiments in which the computer system is a game system, the user may be a sole player of the game system, or one of a plurality of players.

In some embodiments, computer system 16 may be a personal computer (PC) configured for other uses in addition to gaming. In still other embodiments, the computer system may be entirely unrelated to gaming; it may be furnished with input and output componentry and application software appropriate for its intended use.

Computer system 16 includes a vision system 24. In the embodiment shown in FIG. 1, the vision system is embodied in the hardware and software of controller 22. In other embodiments, the vision system may be separate from controller 22. For example, a peripheral vision system with its own controller may be arranged on top of display 18, to better sight user 14, while controller 22 is arranged below the display, or in any convenient location.

Vision system 24 is configured to acquire video of scene 12, and of user 14 in particular. The video may comprise a time-resolved sequence of images of spatial resolution and frame rate suitable for the purposes set forth herein. The vision system is configured to process the acquired video to identify one or more postures and/or gestures of the user, and to interpret such postures and/or gestures as input to an application and/or operating system running on computer system 16. Accordingly, the vision system as illustrated includes cameras 26 and 28, arranged to acquire video of the scene.

The nature and number of the cameras may differ in the various embodiments of this disclosure. In general, one or more cameras may be configured to provide video from which a time-resolved sequence of three-dimensional depth maps is obtained via downstream processing. As used herein, the term ‘depth map’ refers to an array of pixels registered to corresponding regions of an imaged scene, with a depth value of each pixel indicating the depth of the corresponding region. ‘Depth’ is defined as a coordinate parallel to the optical axis of the vision system, which increases with increasing distance from vision system 24—e.g., the Z coordinate in FIG. 1.

In one embodiment, cameras 26 and 28 may be right and left cameras of a stereoscopic vision system. Time-resolved images from both cameras may be registered to each other and combined to yield depth-resolved video. In other embodiments, vision system 24 may be configured to project onto scene 12 a structured infrared illumination comprising numerous, discrete features (e.g., lines or dots). Camera 26 may be configured to image the structured illumination reflected from the scene. Based on the spacings between adjacent features in the various regions of the imaged scene, a depth map of the scene may be constructed.

In other embodiments, vision system 24 may be configured to project a pulsed infrared illumination onto the scene. Cameras 26 and 28 may be configured to detect the pulsed illumination reflected from the scene. Both cameras may include an electronic shutter synchronized to the pulsed illumination, but the integration times for the cameras may differ, such that a pixel-resolved time-of-flight of the pulsed illumination, from the source to the scene and then to the cameras, is discernible from the relative amounts of light received in corresponding pixels of the two cameras. In still other embodiments, the vision system may include a color camera and a depth camera of any kind. Time-resolved images from color and depth cameras may be registered to each other and combined to yield depth-resolved color video.

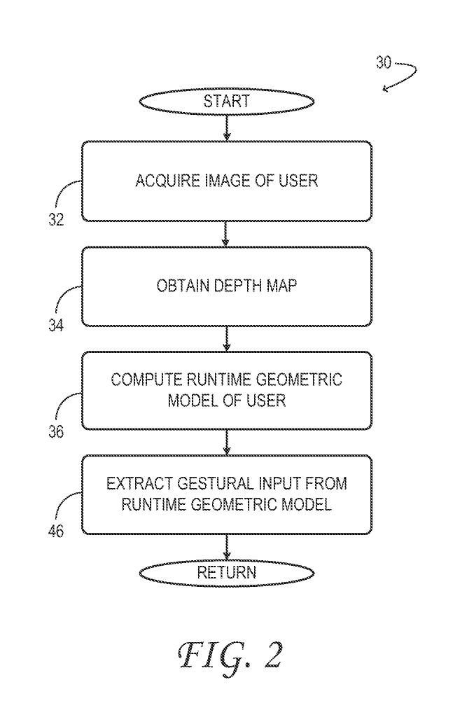

From the one or more cameras, image data may be received into process componentry of vision system 24 via suitable input-output componentry. Embodied in controller 22 (vide infra), such process componentry may be configured to perform any method described herein, including, for instance, the method illustrated in FIG. 2.

FIG. 2 illustrates an example high-level method 30 for obtaining gestural input from a user of a computer system. At 32 of method 30, the vision system of the computer system acquires one or more images of a scene that includes the user. At 34 a depth map is obtained from the one or more images, thereby providing three-dimensional data from which the user's posture and/or gesture may be identified. In some embodiments, one or more background-removal procedures—e.g., floor-finding, wall-finding, etc.—may be applied to the depth map in order to isolate the user and thereby improve the efficiency of subsequent processing.

At 36 the geometry of the user is modeled to some level of accuracy based on information from the depth map. This action yields a runtime geometric model of the user—i.e., a machine readable representation of the user's posture.

FIG. 3 schematically shows an example geometric model 38A of a human subject. The model includes a virtual skeleton 40 having a plurality of skeletal segments 40 pivotally coupled at a plurality of joints 42. In some embodiments, a body-part designation may be assigned to each skeletal segment and/or each joint. In FIG. 3, the body-part designation of each skeletal segment 40 is represented by an appended letter: A for the head, B for the clavicle, C for the upper arm, D for the forearm, E for the hand, F for the torso, G for the pelvis, H for the thigh, J for the lower leg, and K for the foot. Likewise, a body-part designation of each joint 42 is represented by an appended letter: A for the neck, B for the shoulder, C for the elbow, D for the wrist, E for the lower back, F for the hip, G for the knee, and H for the ankle. Naturally, the skeletal segments and joints shown in FIG. 3 are in no way limiting. A geometric model consistent with this disclosure may include virtually any type and number of skeletal segments and joints.

In one embodiment, each joint may be associated with various parameters—e.g., Cartesian coordinates specifying joint position, angles specifying joint rotation, and additional parameters specifying a conformation of the corresponding body part (hand open, hand closed, etc.). The model may take the form of a data structure including any or all of these parameters for each joint of the virtual skeleton. In this manner, all of the metrical data defining the geometric model—its size, shape, orientation, position, etc.—may be assigned to the joints.

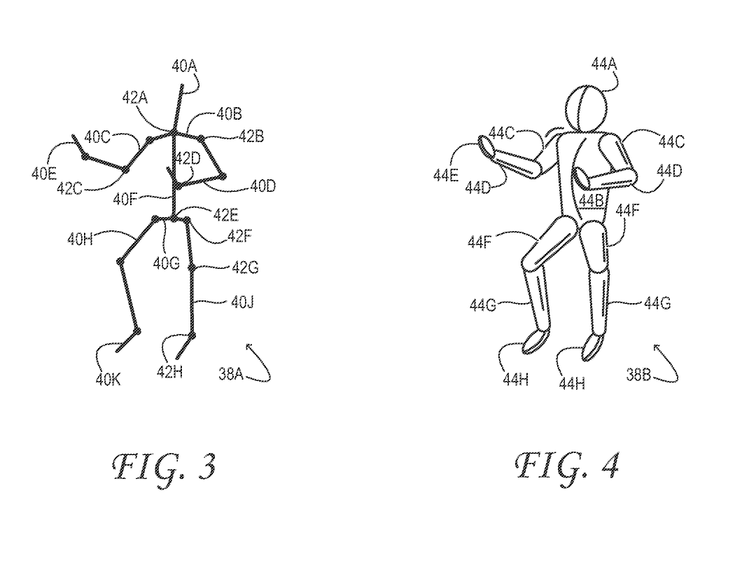

FIG. 4 shows a different geometric model 38B equally consistent with this disclosure. In model 38B, a geometric solid 44 is associated with each skeletal segment. Geometric solids suitable for such modeling are those that at least somewhat approximate in shape the various body parts of the user. Example geometric solids include ellipsoids, polyhedra such as prisms, and frustra.

Returning now to FIG. 2, the skeletal segments and/or joints of the runtime geometric model may be fit to the depth map at step 36 of the method 30. This action may determine the positions, rotation angles, and other parameter values of the various joints of the model. Via any suitable minimization approach, the lengths of the skeletal segments and the positions and rotational angles of the joints of the model may be optimized for agreement with the various contours of the depth map. In some embodiments, the act of fitting the skeletal segments may include assigning a body-part designation to a plurality of contours of the depth map. Optionally, the body-part designations may be assigned in advance of the minimization. As such, the fitting procedure may be informed by and based partly on the body-part designations. For example, a previously trained collection of geometric models may be used to label certain pixels from the depth map as belonging to a particular body part; a skeletal segment appropriate for that body part may then be fit to the labeled pixels. If a given contour is designated as the head of the subject, then the fitting procedure may seek to fit to that contour a skeletal segment pivotally coupled to a single joint—viz., the neck. If the contour is designated as a forearm, then the fitting procedure may seek to fit a skeletal segment coupled to two joints—one at each end of the segment. Furthermore, if it is determined that a given contour is unlikely to correspond to any body part of the subject, then that contour may be masked or otherwise eliminated from subsequent skeletal fitting.

Continuing in FIG. 2, at 46 of method 30, gestural input derived from the user's posture is extracted from the runtime geometric model. For example, the position and orientation of the right forearm of the user, as specified in the model, may be provided as an input to application software running on the computer system. Such input may take the form of an encoded signal carried wirelessly or through a wire; it may be represented digitally in any suitable data structure. In some embodiments, the gestural input may include the positions or orientations of all of the skeletal segments and/or joints of the model, thereby providing a more complete survey of the user's posture. In this manner, an application or operating system of the computer system may be furnished input based on the model.

It is to be expected, however, that the method of FIG. 2 may have difficulty tracking certain gestures, especially when user 14 is positioned less than ideally with respect to the vision system 24. Example scenarios include occlusion of a body part key to the gesture, ambiguous postures or gestures, and variance in the gesture from one user to the next. In these cases and others, advance prediction of the gesture or range of gestures that a user may perform can improve gesture data tracking and detection. Such prediction is often possible in view of the context of the gestural input.

Accordingly, the approach disclosed herein includes storing an appropriate set of observables for expected gestural input, and mapping those observables to the gestural input. To this end, one or more actors (i.e., human subjects) are observed by a vision system while performing gestural input. The vision system then computes a geometric model of the actor from a depth map, substantially as described above. At the same time, however, another metric that reliably tracks the gesture is acquired via a separate mechanism. The metric may include a wide range of information—e.g., a carefully constructed skeletal model derived from a studio-quality motion-capture system. In other examples, the metric may include kinetic data, such as linear or angular velocities of skeletal segments that move while the gestural input is performed. In still other examples, the metric may be limited to one or more simple scalar values—e.g., the extent of completion of the gestural input, as identified and labeled by a human or machine labeler. Then the metric, together with a representation of the observed geometric model of the actor, is stored in a gesture bank for runtime retrieval by a compatible vision system.

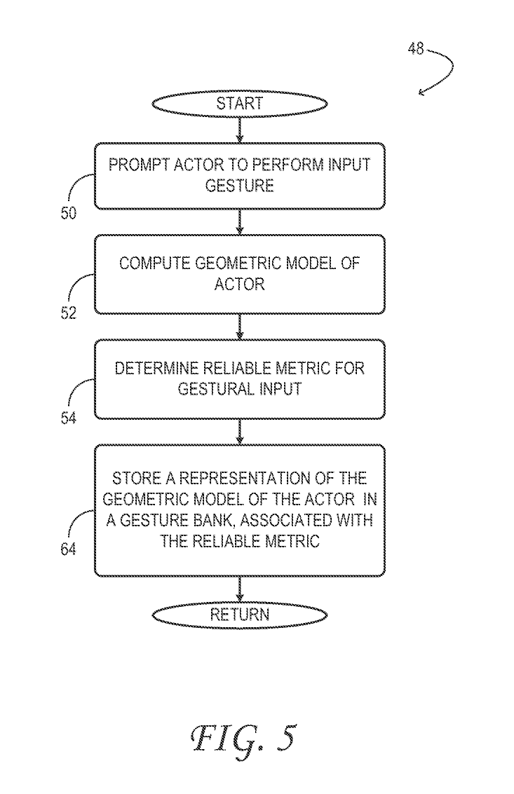

FIG. 5 illustrates in greater detail the gesture bank-population method summarized above. In method 48 at 50, an actor is prompted to perform an input gesture recognizable by a computer system. The input gesture may be expected input for a video-game or other application, or for an operating system. For example, a basketball-game application may recognize gestural input from a player that includes a simulated block, hook-shot, slam dunk, and fade-away jump shot. Accordingly, one or more actors may be prompted to perform each of these actions in sequence.

At 52 of method 48, a geometric model of the actor is computed in a vision system while the actor is performing the input gesture. The resulting model is therefore based on an image of the actor performing the gesture. This process may occur substantially as described in the context of method 30. In particular, steps 32, 34, and 36 may be executed to compute the geometric model. In one embodiment, the vision system used to acquire the image of the actor, to obtain a suitable depth map, and to compute the geometric model, may be substantially the same as vision system 24 described hereinabove. In other embodiments, the vision system may differ somewhat.

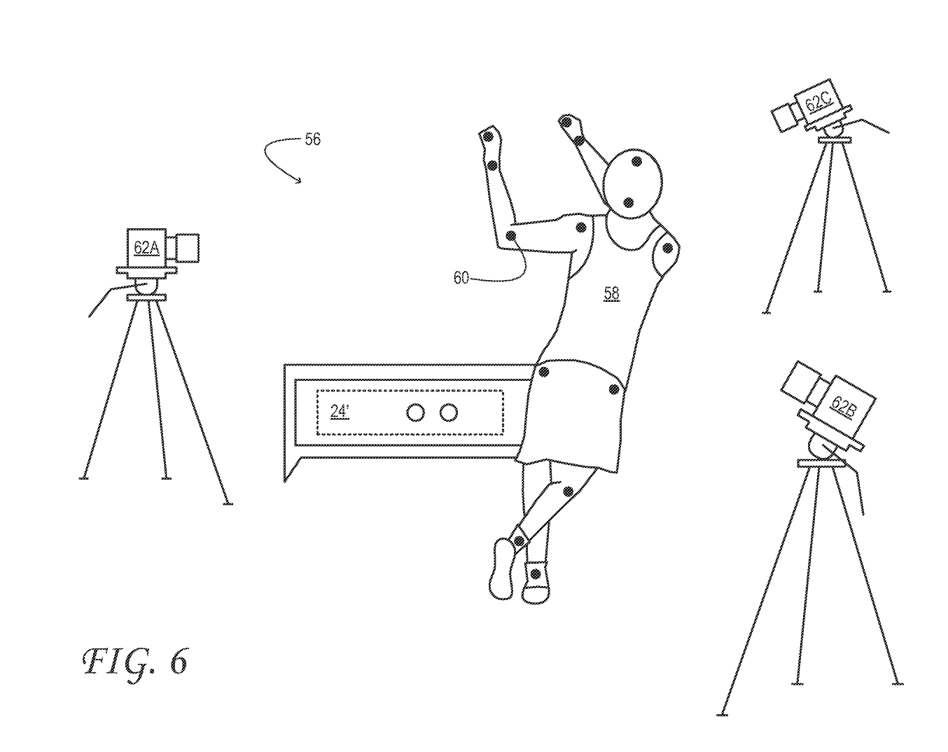

At 54 of method 48, a reliable metric corresponding to the gesture performed by the actor is determined—i.e., measured. The nature of the metric and the manner in which it is determined may differ across the various embodiments of this disclosure. In some embodiments, method 48 will be executed to construct a gesture bank intended for a particular runtime environment (e.g. video game system or application). In such embodiments, the intended runtime environment establishes the most suitable metric or metrics to be determined. Accordingly, a single, suitable metric may be determined for all geometric models of the actor at this stage of processing. In other embodiments, a plurality of metrics may be determined simultaneously or sequentially. In one embodiment, as shown in FIG. 6, a studio-quality motion-capture environment 56 may be used to determine the metric. Actor 58 may be outfitted with a plurality of motion-capture markers 60. A plurality of studio cameras 62 may be positioned in the environment and configured to image the markers. Accordingly, the stored metric may be vector-valued and relatively high-dimensional. It may define, in some examples, the entire skeleton of the actor or any part thereof.

The embodiment of FIG. 6 should not be thought of as necessary or exclusive, for additional and alternative mechanisms are contemplated as well. In one example, the metric determined at 54 may provide only binary information: the actor has or has not raised her hand, the actor is or is not standing on one foot, etc. In another example, the metric may provide more detailed, low-dimensional information: the standing actor is rotated N degrees with respect to the vision system. In still other embodiments, the extent of completion of the actor's input gesture—e.g., 10% completion of a fade-away jump shot, 50% completion, etc.—may be identified. In one particular example, timing pulses from a clock or synchronous counter may be used to establish the extent of completion of the gesture. The timing pulses may be synchronized to a beginning, end, and/or recognizable intermediate stage of the gesture (e.g., by a person with knowledge of how the gesture typically evolves). Accordingly, the range of metrics contemplated herein may comprise a single scalar value or an ordered sequence of scalar values (i.e., a vector) of any appropriate length or complexity.

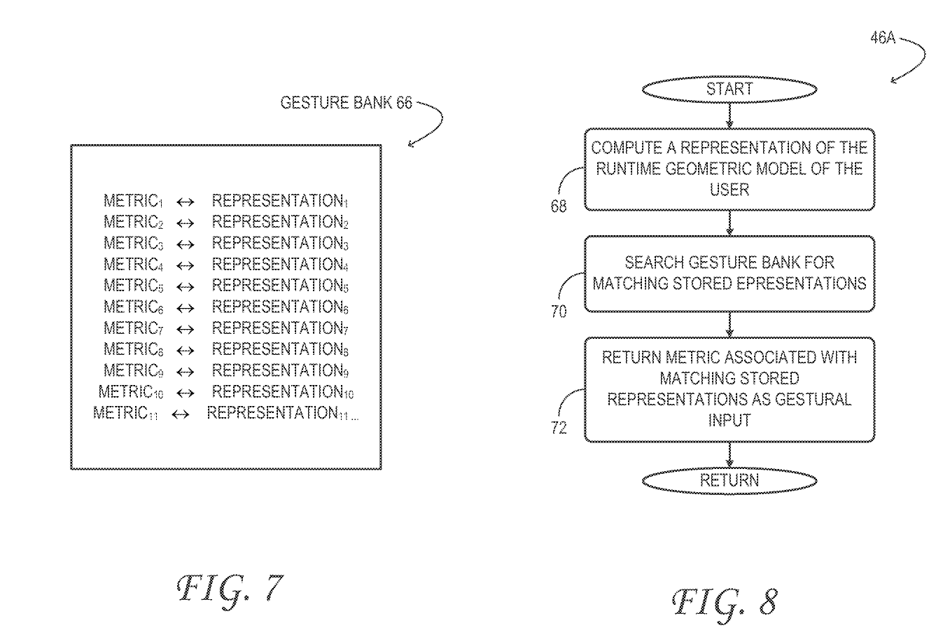

Returning now to FIG. 5, at 64 of method 48, a representation of the geometric model of the actor is stored in a searchable gesture bank (i.e., database) along with the corresponding metric. FIG. 7 illustrates an example gesture bank 66—viz., an ensemble of machine-readable memory components holding data. The data includes a plurality of stored metrics each corresponding to a measurement made on an actor performing a gesture, and, for each stored metric, a stored representation of a geometric model of the actor performing the associated gesture. In one embodiment, each stored metric may serve as an index for the corresponding stored representation. Virtually any kind of geometric-model representation may be computed and stored, based on the requirements of the applications that will access the gesture bank. In some embodiments, the stored representation may be a feature vector amounting to a lower- or higher-dimensional representation of the geometric model.

Before the geometric model is converted to a feature vector, some degree of pre-processing may be enacted. For example, the geometric model may be normalized by scaling each skeletal segment by a weighting factor appropriate for the influence of that segment, or its terminal joints, on the associated gestural input. For example, if the position of the arm is important, but the position of the hand is not important, then shoulder-to-elbow joints may be assigned a large scale, and the hand-to-wrist joints may be assigned a small scale. Pre-processing may also include location of the floor plane, so that the entire geometric model may be rotated into an upright position or given some other suitable orientation. Once normalized and/or rotated, the geometric model may be converted into an appropriate feature vector.

Different types of feature vectors may be used without departing from the scope of this disclosure. As non-limiting examples, a rotation-variant feature vector f_{RV} and/or rotation-invariant feature vector f_{RI} may be used. The more suitable of the two depends on the application that will make use of the gesture bank—e.g., the runtime computing/gaming environment. If, within this environment, the absolute rotation of the user with respect to the vision system distinguishes one gestural input from another, then a rotation-variant feature vector is desired. However, if the absolute rotation of the user makes no difference in the gestural input, then a rotation-invariant feature vector is desired.

One example of a rotation-variant feature vector is that obtained by first translating each skeletal segment of the geometric model so that the starting points of the skeletal segments all coincide with the origin. The feature vector f_{RV} is then defined by the Cartesian coordinates of the endpoints (Xᵢ, Yᵢ, Zᵢ) of each skeletal segment i,

f_{RV}=X₁, Y₁, Z₁, X₂, Y₂, Z₂, . . . , Y_{N}, Y_{N}, Z_{N}.

One example of a rotation-invariant feature vector f_{RI} is an ordered listing of distances (S) between predetermined joints of the geometric model,

f_{RI}=Sᵢⱼ, Sⱼₖ, Sᵢₘ . . .

In some examples, the rotation-invariant feature vector may be appended by a subset of a rotation-variant feature vector (as defined above) in order to stabilize detection.

FIG. 8 demonstrates how a vision system can make use of a gesture bank in which various geometric-model representations, such as feature vectors, are associated each to a corresponding metric. The illustrated look-up method 46A may be enacted during runtime within method 30 (above), as a particular instance of step 46, for example.

At 68 of method 46A, a representation of the runtime geometric model of the user is computed. In other words, each time the vision system returns a model, that model is converted to a suitable representation. In some embodiments, the representation may comprise a rotation-variant or -invariant feature vector, as described above. The runtime representation may be of a higher or lower dimension than the runtime geometric model.

At 70 the gesture bank is searched for matching stored representations. As indicated above, the gesture bank is one in which a plurality of geometric-model representations are stored. The stored representations, each one compatible with the runtime representation, will have been computed based on video of an actor while the actor was performing certain input gestures. Further, each stored representation is associated with a corresponding stored metric that identifies it—e.g., a block, a hook shot, 50% completion of a fade-away jump shot, etc.

In one embodiment, a distance comparison is performed between the feature vector for the runtime geometric model versus all of the stored feature vectors in the gesture bank. One or more matching feature vectors are then identified. During the look-up phase, geometric models are considered similar to the degree that their representations coincide. ‘Matching’ feature vectors are those that coincide to at least a threshold degree or differ by less than a threshold degree. Moreover, feature vectors may be specially defined so as to reflect useful similarity in an application or operating-system environment.

Numerous pre-selection strategies may also be used to limit the range of data to be searched at runtime, depending on context. Accordingly, the searchable data may be pre-selected to include only representations corresponding to gestural input appropriate for a runtime context of the computer system. For example, if the application being executed is a basketball game, then the gesture bank need only be searched for gestural input recognized by the basketball game. Appropriate pre-selection may target only this segment of the gesture bank and exclude gestural input used for a racing game. In some embodiments, further pre-selection may target searchable elements of the gesture bank in view of a more detailed application context. For example, if the user is playing a basketball game and her team is in possession of the ball, gestural input corresponding to defensive plays (e.g., shot blocking) may be excluded from the search.

Continuing in FIG. 8, at 72 of method 46A, a metric associated with the matching stored representations is returned as the user's gestural input. In other words, the vision system compares the runtime representation against stored data, and returns the gestural input based on the stored metrics associated with one or more matching stored representations. For cases in which only one stored representation is identified as a match, the metric corresponding to that representation may be returned as the user's gestural input. If more than one stored representation is identified as a match, the vision system may, for example, return the metric corresponding to the most closely matching stored representation. In another example, an average of several metrics corresponding to matching stored representations may be returned. Metrics included in the average may be those whose associated stored representations match the runtime representation to within a threshold. In yet another example, the metric to be returned may be the result of an interpolation procedure applied to a plurality of metrics associated with a corresponding plurality of matching stored representations.

In scenarios in which the stored metric includes detailed skeletal information, that information may be used to provide context-specific refinement of the runtime geometric model of the user, for more improved skeletal tracking. With respect to this embodiment, it will be noted that some skeletal tracking systems may associate with each joint parameter an adjustable confidence interval. During the matching procedure, confidence intervals can be used to adjust the weighting of the runtime model relative to the skeletal information derived from the stored metric. In other words, each weighting factor may be adjusted upward in response to increasing confidence of location of the corresponding skeletal feature. In this manner, the system can return a more accurate, blended model in cases where the runtime model does not exactly fit the context, especially for front-facing poses in which the user is well-tracked. In a more particular embodiment, appropriate weighting factors for each joint or skeletal segment may be computed automatically during training (e.g., method 48). Moreover, both the geometric model of the actor as well as the reliable metric may be stored in the gesture bank as feature vectors. Accordingly, representation engine 74 may be configured to compute the difference between the two, and thereby derive weighting factors from which to determine the desired contribution of each feature vector at runtime. In yet another embodiment, such blending may be enacted in a closed-loop manner. In this way, the approach here disclosed can transparently improve overall tracking accuracy.

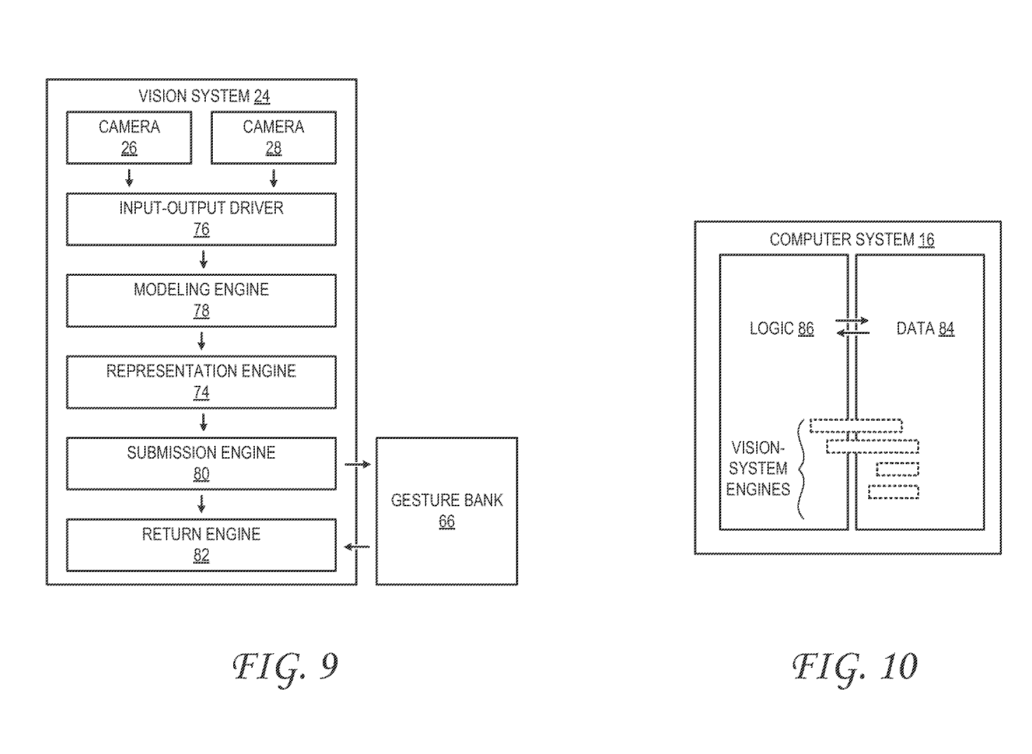

FIG. 9 schematically shows an example vision system 24 configured for use with the methods described herein. In addition to one or more cameras, the vision system includes input-output driver 76 and modeling engine 78. The modeling engine is configured to receive the image and to compute a runtime geometric model of the user. Representation engine 74 is configured to receive the runtime geometric model and to compute a runtime representation of the runtime geometric model. Submission engine 80 is configured to submit the runtime representation for comparison against stored data. Return engine 82 is configured to return the gestural input based on the stored metric associated with a stored representation that matches the runtime representation. FIG. 10, which is further described hereinafter, shows how the various vision-system engines may be integrated within a computer system controller.

It will be understood that the methods and configurations described above admit of numerous refinements and extensions. For example, the feature vectors stored in the gesture bank may be run through a principal component analysis (PCA) algorithm and expressed in PCA space. This variant allows the search for a closest match to be conducted in a lower dimensional space, thereby improving runtime performance. Furthermore, translation of the feature vectors into PCA space may enable a more accurate interpolation between discrete stored metric values. For instance, some types of gestural user input may be adequately and compactly defined by geometric-model representations of only a few key frames of the gesture. The key frames may define the limiting coordinates Q of the gesture. In a basketball game, for example, a defender's arms may be fully raised (Q=1) in one limit, or not raised at all (Q=0) in another. Simple linear interpolation can be done to identify intermediate stages of this gesture at runtime based on the stored limiting cases. An enhancement, however, is to compute the interpolation in PCA space. Accordingly, the return engine may be configured to interpolate, in PCA space, among stored metrics associated with a plurality of stored representations matching the runtime representation. When converted to PCA space, the PCA distance can be used as a direct measure of the progression of the gesture, for improved accuracy especially in non-linear cases.

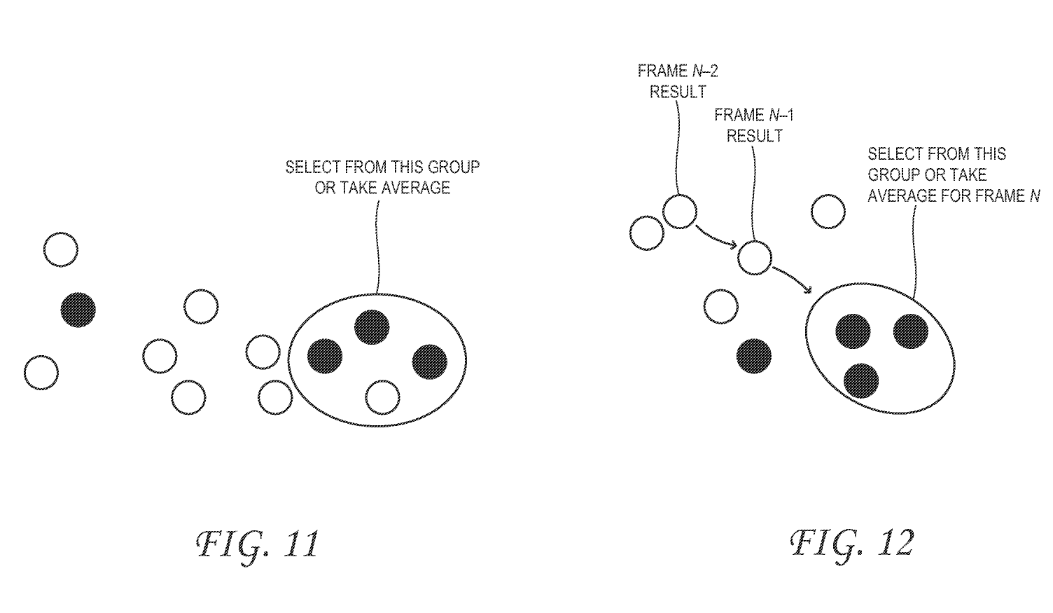

In some scenarios, multiple candidate stored representations may be identified as closely matching the runtime representation. The approach set forth herein enables intelligent selection from among multiple candidates based on pruning. For example, return engine 82 may be configured to only return results that compose a large cluster, limiting the search to values that share proximity in PCA space, as shown in FIG. 11. Here, and in FIG. 12, two-dimensional stored metrics are represented by circles. The filled circles represent close-matching stored metrics, with selected, pruned metrics enclosed by an ellipse. Accordingly, the return engine may be configured to exclude a stored metric insufficiently clustered, in PCA space, with others associated with matching stored representations. In another embodiment, the return engine can look specifically at the direction in which the gesture is progressing (in PCA space), and exclude those poses that are inconsistent with the direction vector, as shown in FIG. 12. Thus, the return engine may be configured to exclude a stored metric lying, in PCA space, outside of a trajectory of metrics associated with matching stored representations for a sequence of runtime representations.

As noted above, the methods and functions described herein may be enacted in computer system 16, shown abstractly in FIG. 10. Such methods and functions may be implemented as a computer application, computer service, computer API, computer library, and/or other computer program product. It will be understood that virtually any computer architecture may be used without departing from the scope of this disclosure.

Computing system 16 includes a logic subsystem 86 and a data-holding subsystem 84. The logic subsystem may include one or more physical devices configured to execute one or more instructions. For example, the logic subsystem may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

Logic subsystem 86 may include one or more processors that are configured to execute software instructions. Additionally or alternatively, the logic subsystem may include one or more hardware or firmware logic machines configured to execute hardware or firmware instructions. Processors of the logic subsystem may be single core or multi-core, and the programs executed thereon may be configured for parallel or distributed processing. The logic subsystem may optionally include individual components that are distributed throughout two or more devices, which may be remotely located and/or configured for coordinated processing. One or more aspects of the logic subsystem may be virtualized and executed by remotely accessible networked computing devices configured in a cloud computing configuration.

Data-holding subsystem 84 may include one or more physical, non-transitory, devices configured to hold data and/or instructions executable by the logic subsystem to implement the herein described methods and processes. When such methods and processes are implemented, the state of the data-holding subsystem may be transformed (e.g., to hold different data).

Data-holding subsystem 84 may include removable media and/or built-in devices. The data-holding subsystem may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard disk drive, floppy disk drive, tape drive, MRAM, etc.), among others. The data-holding subsystem may include devices with one or more of the following characteristics: volatile, nonvolatile, dynamic, static, read/write, read-only, random access, sequential access, location addressable, file addressable, and content addressable. In some embodiments, the logic subsystem and the data-holding subsystem may be integrated into one or more common devices, such as an application specific integrated circuit or a system on a chip.

Data-holding subsystem 84 may include computer-readable storage media, which may be used to store and/or transfer data and/or instructions executable to implement the herein described methods and processes. Removable computer-readable storage media may take the form of CDs, DVDs, HD-DVDs, Blu-Ray Discs, EEPROMs, and/or floppy disks, among others.

It will be appreciated that data-holding subsystem 84 includes one or more physical, non-transitory devices. In contrast, in some embodiments aspects of the instructions described herein may be propagated in a transitory fashion by a pure signal (e.g., an electromagnetic signal, an optical signal, etc.) that is not held by a physical device for at least a finite duration. Furthermore, data and/or other forms of information pertaining to the present disclosure may be propagated by a pure signal.

The terms ‘module,’ ‘program,’ and ‘engine’ may be used to describe an aspect of computer system 16 that is implemented to perform one or more particular functions. In some cases, such a module, program, or engine may be instantiated via logic subsystem 86 executing instructions held by data-holding subsystem 84. It is to be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms ‘module,’ ‘program,’ and ‘engine’ are meant to encompass individual or groups of executable files, data files, libraries, drivers, scripts, database records, etc.

It is to be appreciated that a ‘service’, as used herein, may be an application program executable across multiple user sessions and available to one or more system components, programs, and/or other services. In some implementations, a service may run on a server responsive to a request from a client.

Display 18 may be used to present a visual representation of data held by data-holding subsystem 84. As the herein described methods and processes change the data held by the data-holding subsystem, and thus transform the state of the data-holding subsystem, the state of display may likewise be transformed to visually represent changes in the underlying data. The display may include one or more display devices utilizing virtually any type of technology. Such display devices may be combined with logic subsystem 86 and/or data-holding subsystem 84 in a shared enclosure, or such display devices may be peripheral display devices.

When included, a communication subsystem may be configured to communicatively couple computer system 16 with one or more other computing devices. The communication subsystem may include wired and/or wireless communication devices compatible with one or more different communication protocols. As non-limiting examples, the communication subsystem may be configured for communication via a wireless telephone network, a wireless local area network, a wired local area network, a wireless wide area network, a wired wide area network, etc. In some embodiments, the communication subsystem may allow computer system 16 to send and/or receive messages to and/or from other devices via a network such as the Internet.

The functions and methods disclosed herein are enabled by and described with reference to certain configurations. It will be understood, however, that the methods here described, and others fully within the scope of this disclosure, may be enabled by other configurations as well. The methods may be entered upon when computer system 16 is operating, and may be executed repeatedly. Naturally, each execution of a method may change the entry conditions for subsequent execution and thereby invoke a complex decision-making logic. Such logic is fully contemplated in this disclosure.

Some of the process steps described and/or illustrated herein may, in some embodiments, be omitted without departing from the scope of this disclosure. Likewise, the indicated sequence of the process steps may not always be required to achieve the intended results, but is provided for ease of illustration and description. One or more of the illustrated actions, functions, or operations may be performed repeatedly, depending on the particular strategy being used. Further, elements from a given method may, in some instances, be incorporated into another of the disclosed methods to yield other advantages.

Finally, it will be understood that the articles, systems, and methods described hereinabove are embodiments of this disclosure—non-limiting examples for which numerous variations and extensions are contemplated. Accordingly, this disclosure includes all novel and non-obvious combinations and sub-combinations of the articles, systems, and methods disclosed herein, as well as any and all equivalents thereof.

1. An ensemble of machine-readable memory components holding data, the data comprising:
a plurality of stored metrics each corresponding to a measurement made on an actor performing a gesture; and
for each stored metric, a stored representation of a geometric model of the actor performing the associated gesture.

2. The ensemble of claim 1 wherein each geometric model is based on an image of the actor acquired while the actor is performing the associated gesture.

3. The ensemble of claim 1 wherein each gesture is recognizable by a computer system.

4. The ensemble of claim 1 wherein the ensemble comprises a searchable gesture bank in which each stored metric indexes the associated stored representation.

5. The ensemble of claim 1 wherein each stored metric is vector-valued.

6. The ensemble of claim 5 wherein each stored metric defines the geometry of the actor performing the associated gesture.

7. A computer system configured to receive gestural input from a user, the system comprising:
a camera arranged to acquire an image of the user;
a modeling engine configured to receive the image and to compute a runtime geometric model of the user;
a representation engine configured to receive the runtime geometric model and to compute a runtime representation of the runtime geometric model;
a submission engine configured to submit the runtime representation for comparison against stored data, the data comprising a plurality of stored metrics each corresponding to a measurement made on an actor performing a gesture, and, for each stored metric, a stored representation of a geometric model of the actor performing the associated gesture; and
a return engine configured to return the gestural input based on the stored metric associated with a stored representation that matches the runtime representation.

8. The computer system of claim 7 wherein the runtime representation is of a lower dimension than the runtime geometric model.

9. The computer system of claim 7 wherein the image comprises a three-dimensional depth map.

10. The computer system of claim 7, wherein the submission engine is further configured to enact principal component analysis (PCA) on the runtime representation, and wherein the stored representations are expressed in PCA space.

11. The computer system of claim 10 wherein the return engine is further configured to interpolate, in PCA space, among stored metrics associated with a plurality of stored representations matching the runtime representation.

12. The computer system of claim 10 wherein the return engine is further configured to exclude a stored metric insufficiently clustered, in PCA space, with other stored metrics associated with stored representations matching the runtime representation.

13. The computer system of claim 10 wherein the return engine is further configured to exclude a stored metric lying, in PCA space, outside of a trajectory of stored metrics associated with stored representations matching a sequence of runtime representations.

14. A method for obtaining gestural input from a user of a computer system, the method comprising:
acquiring an image of the user;
computing a runtime geometric model of the user based on the image;
computing a runtime representation of the runtime geometric model;
comparing the runtime representation against stored data, the data comprising a plurality of stored metrics each corresponding to a measurement made on an actor performing a gesture, and, for each stored metric, a stored representation of a geometric model of the actor performing the associated gesture; and
returning the gestural input based on the stored metric associated with a stored representation that matches the runtime representation.

15. The method of claim 14 wherein the stored data is pre-selected to include only representations corresponding to gestural input appropriate for a runtime context of the computer system.

16. The method of claim 14 wherein the stored metric indicates an extent of completion of the gesture performed in the associated stored representation.

17. The method of claim 14 wherein returning the gestural input comprises returning the stored metric associated with the stored representation that most closely matches the runtime representation.

18. The method of claim 14 wherein returning the gestural input comprises returning an average of stored metrics associated with stored representations that match the runtime representation to within a threshold.

19. The method of claim 14 further comprising constructing a weighted average of the runtime representation and a matching stored representation, and wherein returning the gestural input comprises returning gestural input derived from the weighted average.

20. The method of claim 19 wherein the weighted average is constructed based on a plurality of adjustable weighting factors defined for a corresponding plurality of skeletal features of the runtime representation, and wherein each weighting factor is adjusted upward in response to increasing confidence of location of the corresponding skeletal feature.
